(19) United States
(12) Patent Application Publication
(10) Pub. No.: US 2011/0116899 A1
(43) Pub. Date: May 19, 2011

(54) REFUSE DATA COLLECTION SYSTEM

(76) Inventor: Charles E. Dickens, Chesapeake, VA (US)

(21) Appl. No.: 12/776,366

(22) Filed: May 7, 2010

Related U.S. Application Data
(60) Provisional application No. 61/176,289, filed on May 7, 2009.

(51) Int. Cl. B65F 3/04; B65F 3/02; G01G 13/00; B65G 69/00

(52) U.S. Cl. 414/21

(57) ABSTRACT

In general, in one aspect, the disclosure describes a collection vehicle capable of weighing refuse deposited by each customer and transferring the data to a billing system. The weight of a full and empty waste container may be calculated at an arm arrangement using stain gauges. The weight of the contents may be determined after the contents are dumped in a compartment. The compartment may also be capable of sorting out hazardous waste. The vehicle may also be capable of accepting containers having certain contents not normally collected by the vehicle and storing the containers on the vehicle. Other embodiments are described and claimed.

### PRIORITY

This application claims the priority under 35 USC §119 of Provisional Application 61/176,289 entitled “REFUSE DATA COLLECTION SYSTEM” filed on May 7, 2009 and having Charles E. Dickens as inventor. Application 61/176,289 is herein incorporated by reference in its entirety but is not prior art.

### BACKGROUND

Currently, customers pay a fixed fee for refuse collection regardless of the amount of refuse collected. This is not ideal for either the refuse collector or the customer, for a number of reasons. Firstly, the refuse collector is charged a dumping fee at a landfill based on the weight of refuse dumped. Additionally, more trips will be required to the landfill if a greater amount of refuse is collected. Thus, the costs to the refuse collector are largely dependent on the amount of refuse collected. Customers also often feel that it is unfair to charge them the same rate when others may leave a much greater amount of refuse for collection. Another aspect is the desirability of motivating customers to separate out recyclable material from their refuse. Clearly, the motivation would be substantially greater if they could thereby reduce their refuse collection bill. Thus, there is currently a great demand for a system which will permit charging of customers for refuse collection based on the weight of refuse collected. If the weight of both refuse and recyclable material can be effectively and accurately weighed as it is collected, and the weight recorded during curbside collection, customers can be fairly billed based on the weight of refuse collected, and can be credited for recycling appropriate materials.

### BRIEF DESCRIPTION OF THE DRAWINGS

The features and advantages of the various embodiments will become apparent from the following detailed description in which:

FIGS. 1A-1B illustrate a side view and a front cross-sectional view respectively of an example collection vehicle used for collecting refuse or recycling, according to one embodiment;

FIG. 2 illustrates an example arm arrangement utilized by a collection vehicle, according to one embodiment;

FIGS. 3A-B illustrate an example weighing technique where operations of the example arm arrangement are temporarily stopped, according to one embodiment;

FIGS. 4A-B illustrate operational time diagrams for weighing operations being initiated for the raising and lowering of the container, according to one embodiment;

FIG. 5 illustrates an example weighing technique where the weight of the contents may be determined after it is dumped into the vehicle, according to one embodiment;

FIGS. 6A-B illustrate side and front cross-sectional views of the vehicle including a compartment mounted to the top that can be used to weigh the contents after the contents are dumped from the container but before the contents are dumped into the vehicle with the rest of the refuge, according to one embodiment;

FIGS. 7A-B illustrate the use of the compartment in operation, according to one embodiment;

FIGS. 8A-E illustrate the compartment utilized to sort hazardous materials, according to one embodiment;

FIGS. 9A-C illustrate the compartment may also be capable of segregating ferrous (metal) materials and placing them in a separate section in the vehicle, according to one embodiment;

FIGS. 10A-E illustrate various views of an example refuse container, according to one embodiment;

FIGS. 11A-B illustrate side views of an empty and full example recycling container, according to one embodiment;

FIG. 12 illustrates the compartment being utilized to sort recyclables, according to one embodiment;

FIG. 13 illustrates a container (refuse and/or recycling) that is equipped to have another container secured to the top of it, according to one embodiment;

FIGS. 14A-D illustrate the container being removed from the container using the compartment, according to one embodiment; and

FIG. 15 illustrates the top of the vehicle receiving the container, according to one embodiment.

### DETAILED DESCRIPTION

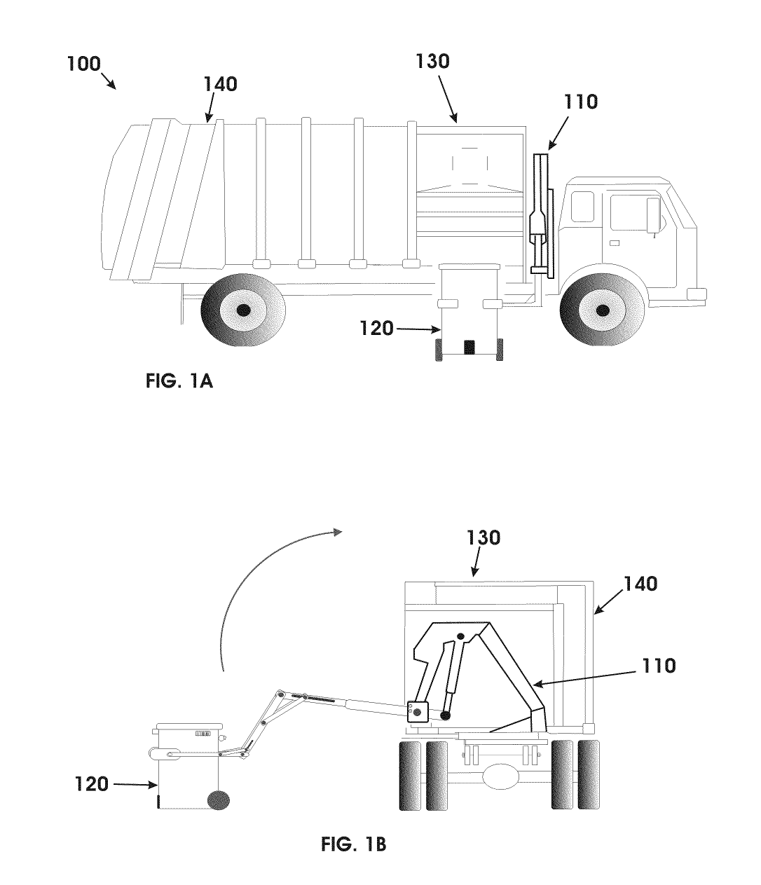

FIGS. 1A-1B illustrate a side view and front cross-sectional view respectively of an example collection vehicle 100 used for collecting refuse or recycling. The collection vehicle 100 may include an arm arrangement 110 for grabbing containers 120 (e.g., refuse containers, recycling containers) and lifting the container 120 to dump the contents (e.g., refuse, recycling) in an opening 130 in the top of the truck 100. After the contents of the container 120 is dumped through the opening 130 it may be compressed and/or relocated to a storage unit 140 in some fashion. The manner and location in which the compression and relocation is performed is beyond the current scope. FIG. 1A illustrates how the arm arrangement 110 is tucked away (possibly behind the cab of the vehicle 100) when not in use. FIG. 1B illustrates how the arm arrangement 110 extends out from the vehicle 100 in order to grab the containers 120.

The weight of the contents may be weighed in some fashion by the arm arrangement 110 (weigh point 1). The arm arrangement 110 may make certain measurements and provide the measurements to an in-vehicle central processing unit (CPU). The CPU may include a processor and processor readable storage medium. The processor readable storage medium may include data and processor executable instructions that when executed by the processor cause the processor to perform certain functions. The CPU may process the measurements and determine the weight based thereon. The measurements may be made and the weight may be determined while the full container 120 is being raised and then again while an empty container 120 is being returned. The weight of the contents may be the full weight minus the empty weight.

The CPU may associate the weight with a customer. The customer may be determined in various means that will be described in detail later. The vehicle 100 may include a display that the operator can utilize to track operations, issue commands and/or document certain activities during the weighing process. The use of the display will be described in more details later. The weight assigned to various customers may be stored in an in-vehicle memory device. The weight assigned to the customers may be transferred in some fashion from the vehicle to a billing system.

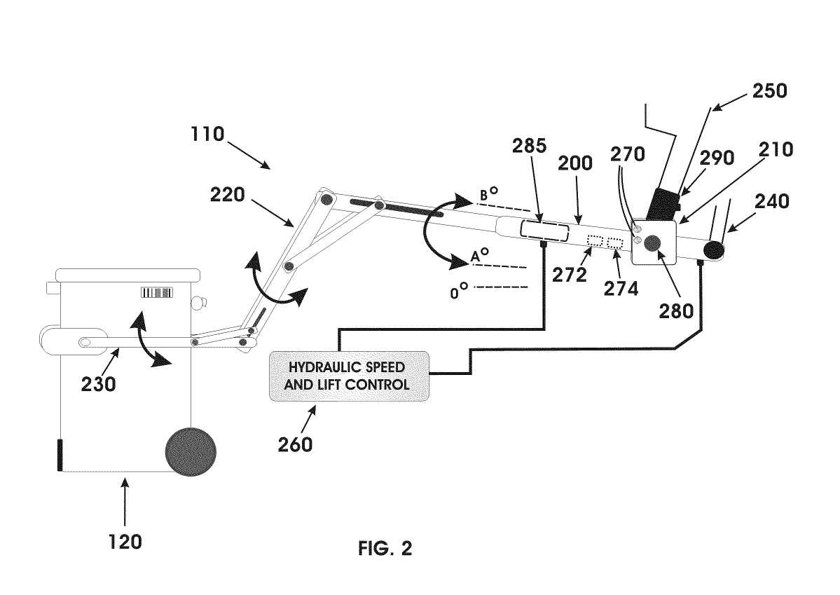

FIG. 2 illustrates a close up view of an example arm arrangement 110 utilized by an example collection vehicle 100. The arm arrangement 110 may include a main shaft 200 that may be pivoted upward or downward around a pivot point 210, an arm 220 that may be pivoted around the main shaft 200, claws 230 that may be pivoted around the arm 220, a pivoting arm 240 that may cause the main shaft 200 to pivot, a lifting shaft 250 for lifting the pivot point 210 and the main shaft 200, and a hydraulic controller 260 to control the hydraulics (not illustrated) utilized therein in order to control the operation thereof. The claws 230 may be used to grab an example container 120.

The movement of the arm arrangement 110 may not be smooth as it begins movement in a direction (e.g., as the full container is initially lifted, empty container is being decent) or is about to stop movement (e.g., full container is about to dumped, empty container is about to be placed on ground). Likewise, the movement of the arm arrangement 110 may not be smooth as various parts of the arm are beginning or ending movement or are moving together. In addition, various other parameters such as the slope of the vehicle 100 and the condition of the hydraulics may make weighing the containers 120 a challenge.

According to one embodiment, the lifting and returning of the container 120 may be temporarily stopped in order for weighing to be performed. The stopping of the operation of the arm arrangement 110 enables measurements to be made that do not have to take movement into account. While this embodiment may provide more accurate or easier to calculate weight measurements the delay in operation may limit the commercial applicability. The less time taken and the more accurate the readings the more likely it may be used commercially.

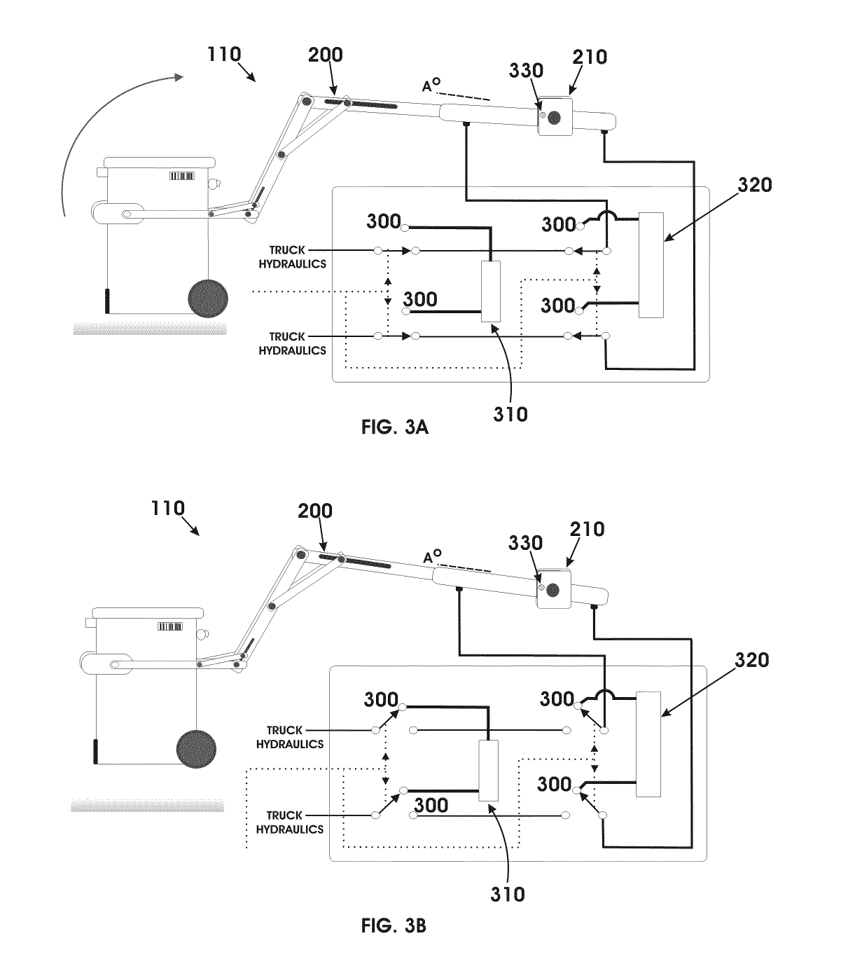

FIGS. 3A-B illustrate an example weighing technique where operations of the example arm arrangement 110 are temporarily stopped. The arm arrangement 110 may include valves 300 that can be utilized to isolate the hydraulic lines (e.g., connect them to an isolation valve 310) and connect the main shaft 200 to, for example, a pressure sensor 320. The pressure sensor 320 may take measurements and provide the measurements to the CPU to determine the weight. Once the weight is determined the valves 300 may be switched back and the hydraulics may continue operating. The weight may be measured in the upward (full load) and download (empty load) directions. The movement of the arm arrangement may be stopped at a defined point. For example, it may be stopped after the container 120 has been lifted a certain amount off the ground. The defined distance above the ground may be determined utilizing a proximity sensor 330 to determine, for example, when the main shaft 200 is at a defined angle A above a reference point (e.g., horizontal position). By way of example only, the defined angle A may be 10 degrees above the reference point. The proximity sensor 330 may be located, for example, on the pivot point 210.

FIG. 3A illustrates the arm arrangement 110 moving in an upward direction before reaching the reference angle A where the hydraulics are operational (the valves 300 are switched such that the hydraulic lines are connected to the arm arrangement 110). FIG. 3B illustrates the arm arrangement 110 as it reaches reference angle A and the hydraulics are isolated (the valves 300 are switched such that the hydraulic lines are connected to the isolation valve 310) and the arm arrangement 110 is connected to the pressure sensor 320. Once the measurement are made the valves 300 are switched back and operation may continue. In the downward motion the arm arrangement 110 may again stop at the reference angle A to take measurements and then continue to place the container 120 on the ground after the measurement is made.

If the stopping of the arm arrangement 110 is not an acceptable alternative for weighing the container, the weighing may need to performed while the arm arrangement is moving. As previously mentioned, when the arm arrangement 110 is in operation multiple parts may be moving, possibly at the same time, and all the starting and stopping of movement and movement of multiple parts at once may cause the arm arrangement 110 to operate in a jumpy fashion. According to one embodiment, the weight measurements may be made while the main shaft 200 is being pivoted within a certain range where most accurate weight readings can be made (e.g., where the movement is the smoothest).

Referring back to FIG. 2, the amount of pivoting of the main shaft 200 may be defined between certain angles from a reference point (e.g., between angle A and angle B). By way of example only, the measurements may be made between 6 and 14 degrees from the horizontal. Proximity sensors 270, for example located on the pivot point 210, that correspond to the defined angles may be used to determine when the main shaft 200 is within the defined angles. When the main shaft 210 passes the proximity sensors 270 the weight measurements will either be activated or deactivated. In an upward direction the weighing operations may begin once the main shaft 200 crosses reference angle A (proximity sensor 270 associated with reference angle A is activated) and cease when the main shaft 200 crosses reference angle B. In the downward direction it may be the opposite.

In order to make weight measurements based on consistent operations, the hydraulic control 260 may attempt to maintain the main shaft 200 moving at a steady speed while the weight measurements are being made. As the speed that the hydraulics move the main shaft 200 may depend on any number of parameters as noted above measurements related to the speed may be made and feed back to the hydraulic controller 260 so adjustments can be made. For example, the arm arrangement 110 may include an accelerometer 272 located, for example, on the main shaft 200 that measures the acceleration of the main shaft 200 and these measurements may be feed back to the hydraulic controller 260. The arm arrangement 110 may include an gyroscope 274 located, for example, on the main shaft 200 that measures the angle of the main shaft 200 and these measurements may be feed back to the hydraulic controller 260. The hydraulic controller 260 may adjust its operation to attempt to keep a steady speed with the weight measurement window.

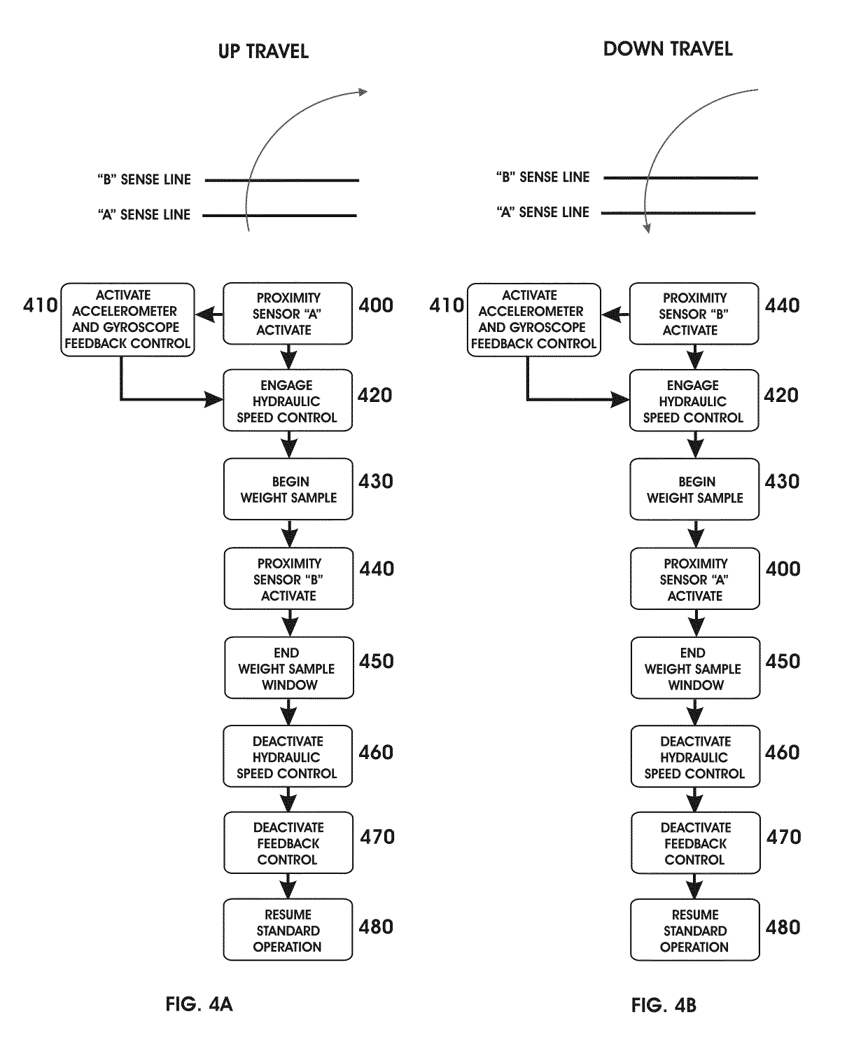

FIGS. 4A-B illustrate operational time diagrams for weighing operations being initiated for the raising and lowering of the container 120. FIG. 4A illustrates the raising mode passing sensor A first and then sensor B. When the sensor A is activated 400, for example, when the main shaft 200 passes thereby, the accelerometer 272 and/or the gyroscope 274 may be activated 410 and the hydraulic controller 260 may enter a speed control mode 420 and receive feedback from the accelerometer 272 and/or the gyroscope 274 and make adjustments thereto. The weighing operations are then begun 430 (the various weighing options will be discussed in detail later). When the sensor B is activated 440, for example when the main shaft 200 passes thereby, the weighing operations are concluded 450 and the accelerometer 272 and/or the gyroscope 274 may be deactivated 460 and the hydraulic controller 260 may exit speed control mode 470 and normal operations may resume 480.

FIG. 4B illustrates the lowering mode passing sensor B first and then sensor A. When the sensor B is activated 440 the accelerometer 272 and/or the gyroscope 274 may be activated 410, the hydraulic controller 260 may enter speed control mode 420, and the weighing operations may begin 430. When the sensor A is activated 400, the weighing operations are concluded 450, the accelerometer 272 and/or the gyroscope 274 may be deactivated 460 and the hydraulic controller 260 may exit speed control mode 470 and normal operations may resume 480.

During the weighing window (from 430 to 450), multiple measurements may be made and the multiple measurements may be provided to the CPU for conversion to weight. The CPU may utilize an algorithm to convert the multiple measurements to a weight. The weight associated with the down motion may be subtracted from the weight of the up motion to get the weight associated with the contents.

Referring back to FIG. 2 we will describe various means for weighing the containers 120. The pivot point 210 may include a rotary torque sensor 280 that measures the torque caused by the downward pulling forces (e.g., weight of the container 120) at this point. The rotary torque sensor 280 may either be a shaft or gear mounted sensor. The torque measured by the rotary torque sensor 280 may include contributions from, for example, the main shaft 200, the arm 220, and the claws 230. However, since measurements are being made in both directions the torque associated with the arm arrangement 110 may be factored out.

According to one embodiment, other measurements may be provided to the CPU and the CPU may utilize these measurements to help determine the weight. For example, the acceleration and angle measurements from the accelerometer 272 and the gyroscope 274 may be provided to the CPU. In addition, sensors measuring temperature, humidity and other factors may be included (not illustrated) and the measurements from these devices may be provided to the CPU. These monitors may be provided, for example, in close proximity to the rotary torque sensor 280.

According to one embodiment, strain sensors 285 may be included on the main shaft 200 to determine the amount of strain (e.g., bending, displacement) on the main shaft 200. Any number of strain sensors 285 could be utilized including optical, acoustics and foil sensors. Each of these sensors 285 may determine the effect that the strain on the main shaft 200 causes on the sensor 285. For example, the strain sensor 285 may determine the change in light or sound waves being transmitted along a surface of the main shaft 200. The measurements may be transmitted to the CPU where the CPU may convert the measurements to weight. Again, other parameters may be captured and transmitted to the CPU and the CPU may utilize these measurements in the determination of weight. The measurements of the other parameters may be made in close proximity to the stress sensors 285.

According to one embodiment, a load cell 290 may be included in the lifting arm 250. The load cell 290 may be utilized to measure displacement of the plate 290 from a reference point and these measurements may be utilized by the CPU to determine weight. As the load cell 290 may need to physically be located within the arm arrangement 110 it may be difficult to locate it in the main shaft 200 like the other measurement techniques due to the hydraulics contained therein. The load cell 290 may be located in the lifting arm 250 in close proximity to the pivot point 210. The measurements from the load cell 290 may be provided to the CPU for weight determination and other measurements may be provided thereto as well and these measurements may be utilized by the CPU in the weight determination. The measurements of the other parameters may be made in close proximity to the load cell 290.

According to one embodiment, more then one of these weight measurement techniques may be included and the CPU may determine the weight based on all the information provided thereto.

It should be noted that the various weighing methods taking place at the arm arrangement 110 described in FIGS. 2-4 were active based on movement of the main shaft 200 with relation to reference angles. It should be noted that the invention is in no way intended to be limited thereby. Rather, the weighing methods could be active based on fairly constant acceleration of the main shaft 200 as determined by the measurements from the accelerometer. Furthermore, the weighing methods are not limited to being active based on movement of the main shaft 200. Rather, the weighing measurements may be active based on movements of the arm 220 or the claws 230. Moreover, the weighing methods were based on measurements made (e.g., torque, load, strain, acceleration, angle) at or around the main shaft 200. It should be noted that the measurements are not limited to those locations but rather can be made at various locations on the arm arrangement 110 (e.g., the arm 220, the claws 230). Additionally, the arm arrangement 110 was simply an example arrangement. The weight measurements can be made in various different arm arrangements without departing from the current scope.

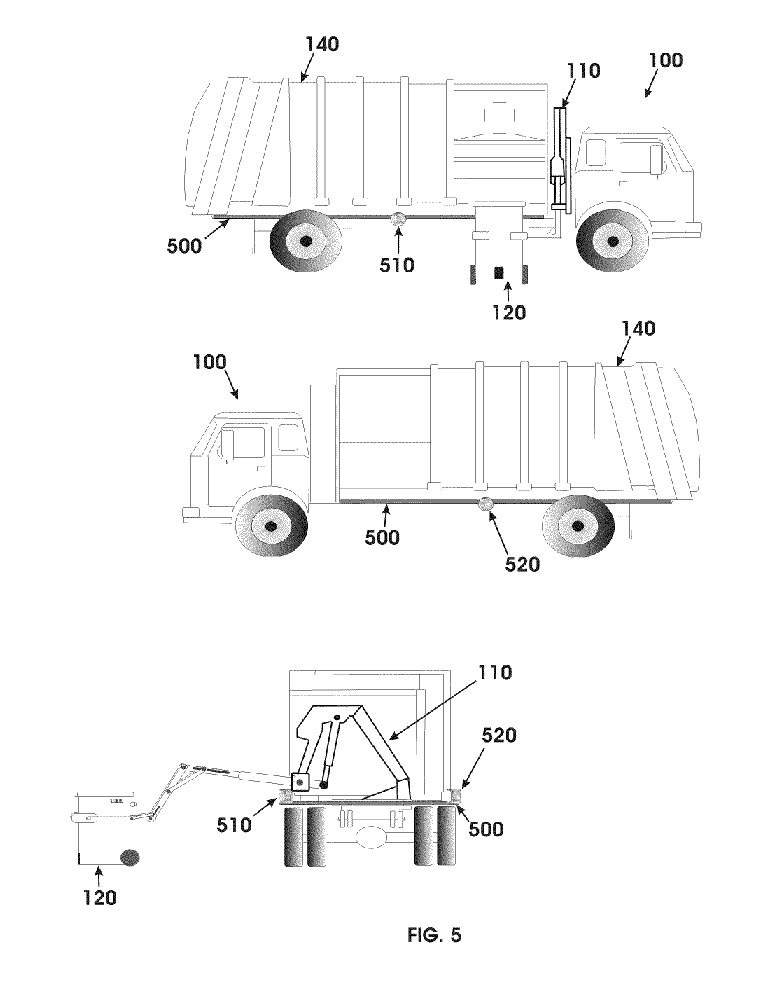

FIG. 5 illustrates an embodiment in which the weight of the contents may be determined after it is dumped into the vehicle 100. The bottom of the vehicle 100 may include a load bearing medium 500 (weigh point 2). The load bearing medium 500 may include one or more strain sensors (e.g., acoustic) to measure the strain on the medium 500. The strain sensor may include a source (e.g., acoustic source) 510 and a receiver (e.g., acoustic receiver) 520. The difference is the signal transmitted from the source 510 and the signal received by the receiver 520 may determine the strain on the medium 500. The measured (or determined) strain may be provided to the CPU that can convert the strain to weight. The CPU may then subtract the previous weight (before the just added contents) from the current weight (including the just added contents). Other parameters (e.g., temperature, humidity) may be provided to the CPU and the CPU may utilize these additional parameters in determining the weight. Weigh point 2 may be utilized instead of or in addition to weigh point 1.

The load bearing medium 500 tracks the overall weight of the load in order to determine the weight of each individual dump of a container 120. Knowing the overall weight of the load may enable the CPU to transmit the overall weight to a dump station rather then requiring the dump station to have a scale to determine the weight of the load.

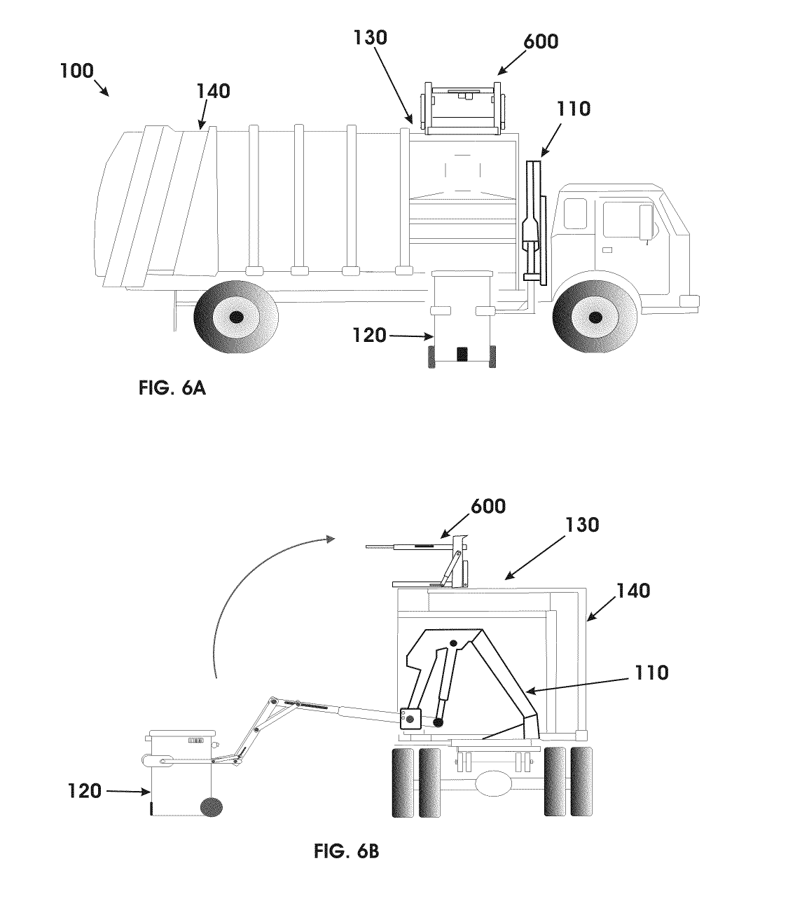

FIGS. 6A-B illustrate side and front cross-sectional views of an embodiment in which the vehicle 100 includes a compartment 600 mounted to the top of the vehicle 100 that can be used to weigh the contents after the contents are dumped from the container 120 but before the contents are dumped into the vehicle 100 with the rest of the refuge (weigh point 3). Weigh point 3 may be utilized instead of weigh point 1 or weigh point 2 or in addition to some combination of those.

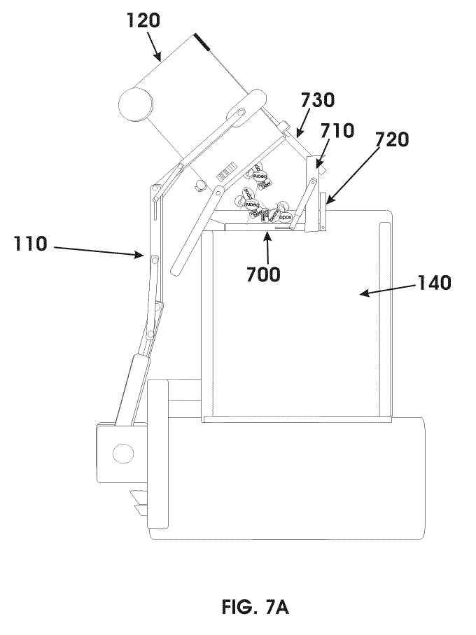

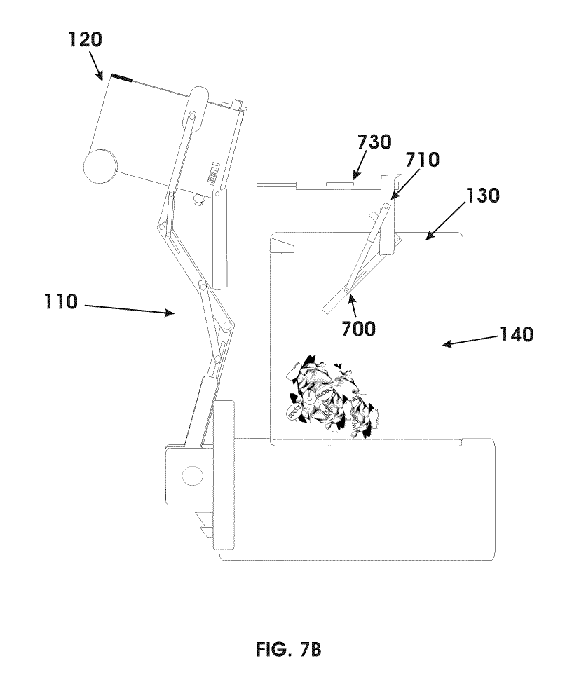

FIGS. 7A-B illustrate the use of the compartment 600 (weigh point 3) in operation. As illustrated, the compartment 600 covers a portion of the opening 130 that the refuge would normally enter the storage unit 140. The compartment 600 includes a floor that is a load bearing medium 700 that may be equipped with a weighing mechanism (e.g., acoustic strain gauge) to measure the strain that may be provided to the CPU for the CPU to calculate weight of the contents. In addition to a weighing mechanism the compartment 600 may also include sensors that measure other parameters that may affect the weight such as temperature and humidity. These sensors may be located anywhere in the compartment 600 including on, in, or under the load bearing medium 700. The compartment 600 may also include side walls 710 mounted to the vehicle 100 and utilized to secure the load bearing medium 700, a back wall 720 to maintain the contents on the load bearing medium 700, and a top wall 730 that may be used to guide the receptacle 120 and to protect the load bearing medium 700 from the elements.

FIG. 7A illustrates the contents being dumped from the container 120 to the compartment 600. The back wall 720 prevents the contents from rolling off the load bearing medium 700 and into the storage unit 140. The contents are weighed by the load bearing medium 700 after they are received. It should be noted that the measurements can be made while the container 120 is being returned to the ground. FIG. 7B illustrates the load bearing medium 700 pivoting down to allow the contents to enter the storage unit 140 after the contents have been weighed.

The compartment 600 may be capable of sorting the contents in addition to or instead of weighing the contents. For example, the compartment 600 may include sensors that can detect hazardous materials. The sensors may be located in the load bearing medium 700. If the sensors detect that hazardous materials are included in the contents the contents may be dumped in a hazardous material bin.

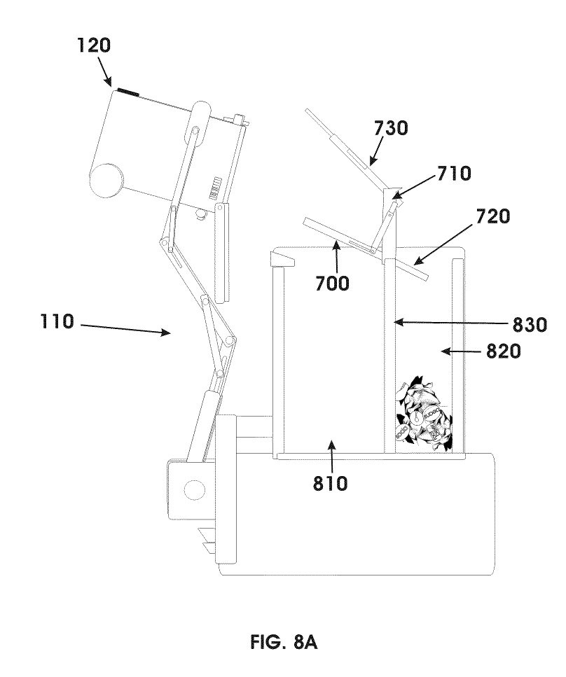

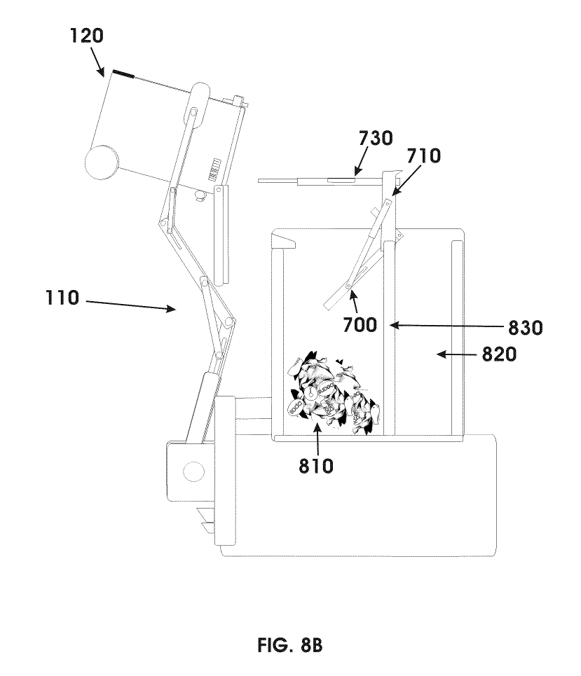

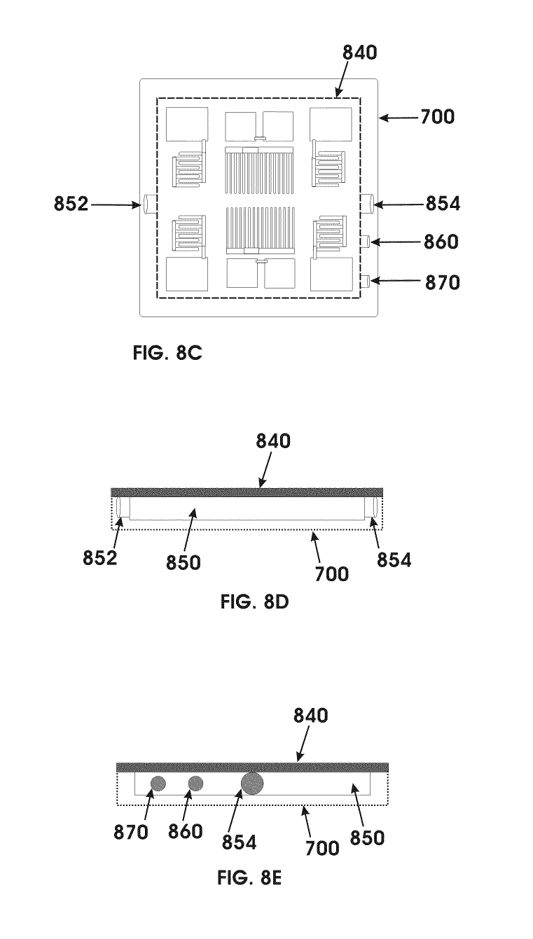

FIGS. 8A-E illustrate an embodiment in which the compartment 600 is utilized to sort hazardous materials. The storage unit 140 may be divided into sections where a first (front as illustrated) section 810 is for refuse and a second (back as illustrated) section 820 is for hazardous waste using a wall 830. The compartment 600 may include an array of multi-functional sensors 840 to detect hazardous materials and/or unauthorized refuse. For example, the sensors may include chemical, vapor and particulate sensors. If the contents is determined to be hazardous the contents are dumped into the second section 820 and if they are not they are dumped into the first section 810. The sensors 840 may be located on the load bearing medium 700. The sensors 840 may take measurements and report the measurements to the CPU and the CPU may determine if the contents are hazardous and direct the compartment 600 which way to dump. Alternatively, the sensors 840 may determine if the material is hazardous and based on this determination the compartment 600 may determine which way to dump the contents.

FIG. 8A illustrates the contents being determined to be hazardous and being dumped into the second section 820. In order to dump the contents into the second section 820 the load bearing medium 700 is tilted backwards and the back wall 720 is swung down. FIG. 8B illustrates the contents being determined to be non-hazardous and being dumped into the first section 810. The load bearing medium 700 is pivoted forward to allow the contents to enter the first section 810.

FIGS. 8C-E illustrate several views of the load bearing medium 700 utilized to detect hazardous materials. FIG. 8C illustrates a top view that shows the array of sensors 840 on an upper surface thereof, and portions of a weight sensor (e.g., acoustic strain gauge) source 852, weight sensor receiver 854, temperature sensor 860, and humidity sensor 870 exiting the sides thereof. FIG. 8D illustrates a frond side view showing a weight sensor 850 traversing the length of the load bearing medium 700 with the source 852 on one side and the receiver 854 on the other side. As described previously, the difference between the acoustic waves at the source 852 and the receiver 854 is utilized to determine the strain which is then utilized to determine the weight. FIG. 8E illustrates a right side view showing the weight sensor receiver 854, the temperature sensor 860, and the humidity sensor 870.

According to one embodiment, the containers 120 may include an array of multi-functional sensors 840 to detect hazardous materials and/or unauthorized refuse. The sensors 840 may be located on bottom of the refuse container 120. The refuse container 120 and the vehicle 100 may be equipped with wireless communications. The vehicle 100 and the container 120 may communicate with regard to hazardous materials being included in the container. If the vehicle 100 receives an indication from the container 120 that the refuse contained therein is hazardous the vehicle 100 may opt to not take the refuse or it may utilize the indication to direct the compartment 600 to dump the refuse into the second (hazardous) section 820. The sensors 840 in the container may be in place of the sensors in the compartment 600 or may be in addition thereto.

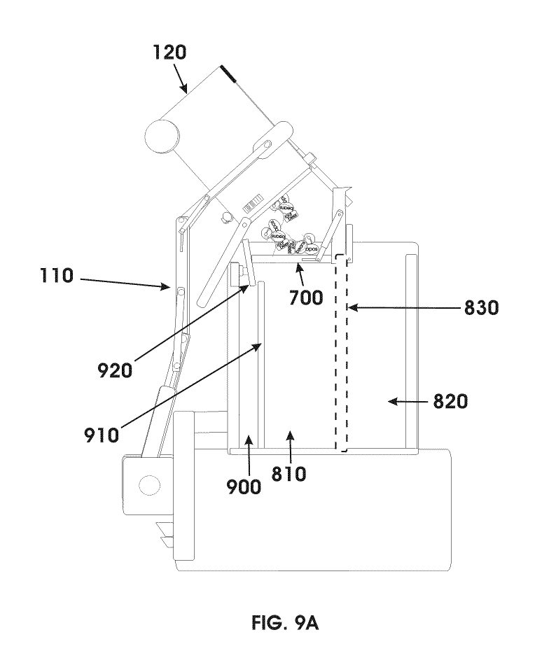

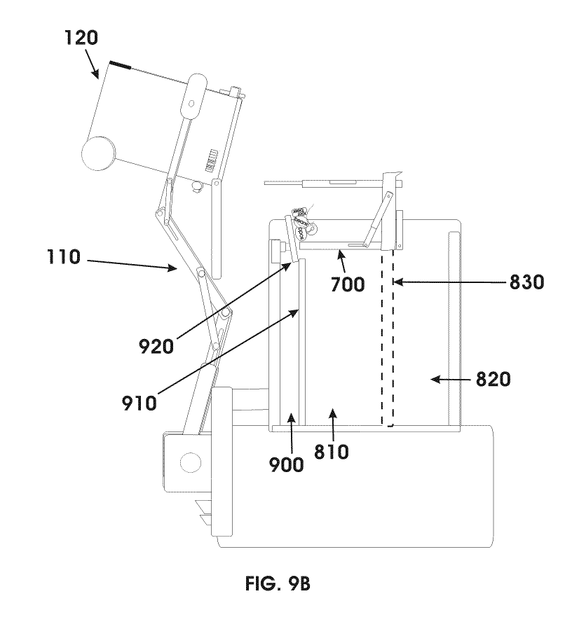

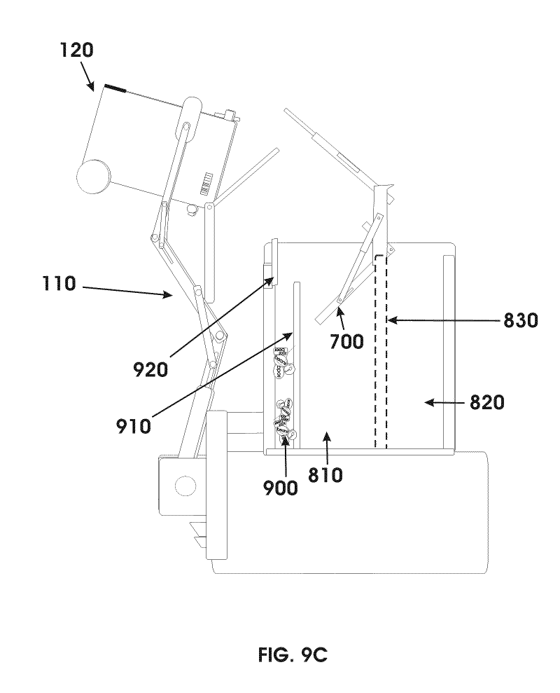

FIGS. 9A-C illustrate an embodiment in which the compartment 600 may also be capable of segregating ferrous (metal) materials and placing them in a separate section 900 in the vehicle 100 that is separated from the rest of the storage unit 140 (possibly divided into sections 810, 820) via a wall 910. The vehicle 100 may include a moveable magnetic plate 920 located at an upper edge of the wall 910 and in alignment with the load bearing medium 700. When activated the magnetic plate 920 may pull metal contents theretowards. After the metal contents are pulled toward the magnetic plate 920 the magnetic plate 920 may be retracted such that the section 900 is accessible. The magnetic plate 920 may then be deactivated and the contents may fall into the section 900.

According to one embodiment, the metal refuse may be provided separate from the rest of the refuse if the container 120 has a separate section (e.g., on top) for storing metallic refuse (to be discussed in more detail later). Alternatively, all the refuse may be dumped into the compartment 600 together and the magnetic plate 920 may be utilized to pull the metallic refuse to the front for segregating to the section 900.

In order for the weight associated with the refuse collected to be associated with a customer the customer needs to be identified. One way to identify the customer would be for the vehicle 100 to contain a route map that the CPU could present on a display in the vehicle 100. An operator of the vehicle 100 may select the customer from the route map. The vehicle 100 may include a GPS system to track the vehicles location and indicate this on the route map to aid the operator in selecting the appropriate customer.

A more automated way to identify the customers is to mark the containers 120 with a radio frequency identification code (RFID) tag or bar code that contains the customer's data. The vehicle 100 may include an RFID reader or bar code reader that can read the RFID tag or bar code in order to gather the customer's data. Use of barcodes would require that the reader be in close proximity to the barcode in order for reading to occur. Use of RFID would not require that the reader be that close in order for reading to occur (RFID has a greater range). The RFID/barcode reader may be located at various locations on the vehicle (e.g., arm arrangement 110, compartment 600). For existing containers 120 a bar code or RFID tag may be placed thereon. For new containers a bar code or RFID tag may be integrated thereinto.

The vehicle may include a GPS and a route map to validate that the address associated with the RFID tag (or barcode) read for the container 120 is accurate. The operator may be prompted when there is a discrepancy. The CPU may also include an algorithm that tracks how far the vehicle has traveled from a confirmed pickup in case the GPS signal is lost it may determine an approximate location and place the approximate location on the route map.

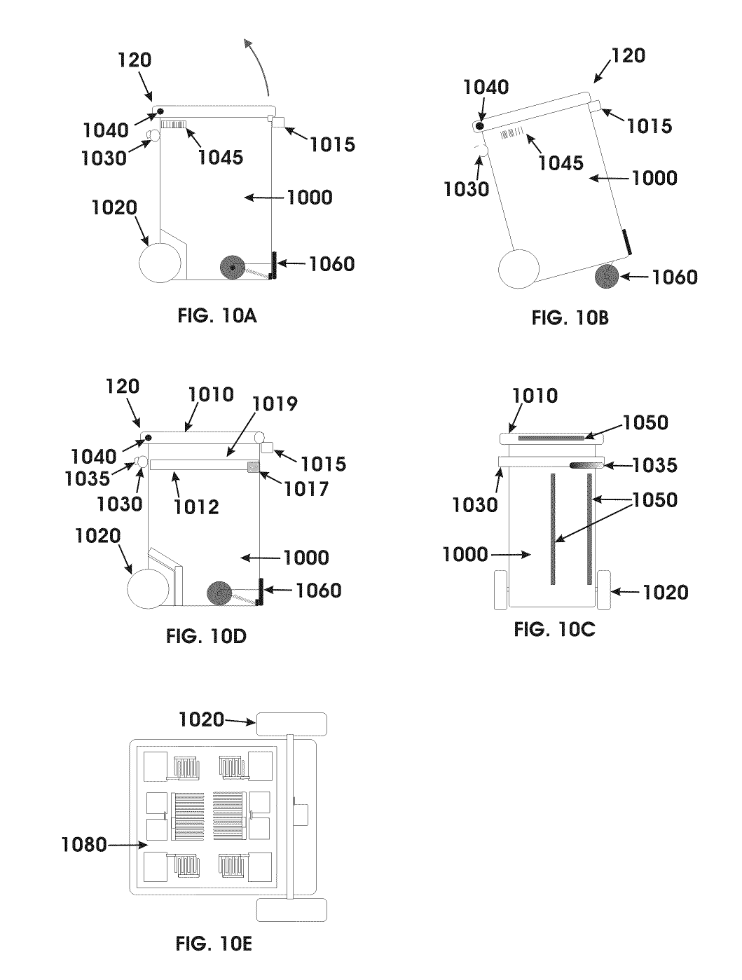

FIGS. 10A-E illustrate various views of an example refuse container 120. The container 120 may include a body 1000, a hinged lid 1010, wheels 1020 located on one end of the bottom in order to roll the container 120, and a handle 1030 to pull the container 120. The container 120 may include a locking mechanism 1015 to secure the lid 1010 in a closed position so refuse can not be placed by others in the container 120. This may be important if customers are going to be charged by weight. The locking mechanism 1015 may be capable of manual being opened by the customer and electronically opened by the vehicle. The locking mechanism may be capable of wireless communications so that it can receive a code from the vehicle that will cause the locking mechanism to unlock.

An RFID device 1040 may be integrated into the container 120, for example, it may be integrated into the hinge mechanism. Alternatively, an RFID tag 1045 may be secured to an exterior of the container 120. The container 120 may include guide strips 1050 that may be utilized to assist the vehicle 100 in correctly engaging the container 120. The vertical guide strips 1050 may be utilized to assist the vehicle 100 align with the container 120 while the horizontal strip 1050 may be utilized to determine when the container 120 has been lifted to the appropriate height. The vehicle 100 may include a camera or optical sensors in order to utilize the guide strips 1050.

The container 120 may include a retractable wheel 1060 that may be used to assist in moving the container 120. The retractable wheel 1060 may be dropped utilizing a wheel release lever 1035 integrated into the handle 1030. Stabilizer weights 1070 mat be integrated into the container to prevent the container 120 from tipping over or being blown away.

The container 120 may include a second hinged lid 1012 within the container 120 and a second locking device 1017. The second hinged lid 1012 may create a second compartment 1019 within the container 120 that can be used to store, for example, metal objects. If the customer wanted to deposit refuse in the container 120 they would lift the second lid 1012 providing access to the bottom container 1000. If they wanted to deposit metal objects they would lift the first lid 1010 (and the second lid 1012 would remain closed) providing access to the second compartment 1019.

The container 120 may include an array of multi-functional sensors 1080 to detect hazardous materials and/or unauthorized refuse. For example, the sensors 1080 may include chemical, vapor and particulate sensors. The sensors 1080 may be located on the bottom of the container 120. The sensors 1080 may include a wireless transceiver to communicate with the vehicle 100 with regard to inclusion of hazardous contents.

FIG. 10A illustrates a side view of the container 120 with the retractable wheel 1060 retracted and FIG. 10B illustrates a side view with the wheel 1060 extended. FIG. 10C illustrates a rear view showing the guide stripes 1050. FIG. 10D illustrates a side view of a container 120 including the second lid 1012 and compartment 1019. FIG. 10E illustrates a cross sectional view of the bottom of the container 120 showing the sensors 1080.

The compartment 600 may also be utilized on a recycling vehicle. The compartment may weigh the recyclables and/or may sort them. If the recyclables are going to be sorted a container that is separated may be required.

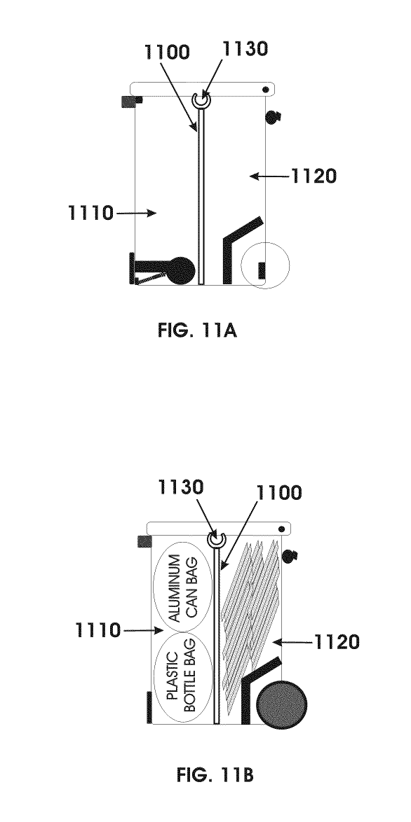

FIGS. 11A-B illustrate side views of an example recycling container 120 empty and full. The container 120 may include a dividing wall 1100 that divides the container 120 into two sides 1110, 1120. One side 1110 may be used to collect, for example, bags of bottles and bags of cans and the other side 1120 may be used to collect, for example, paper products (e.g., newspaper). The dividing wall 1100 may include a groove 1130 for receiving the load bearing medium 700. According to one embodiment the dividing wall 1100 may be removable.

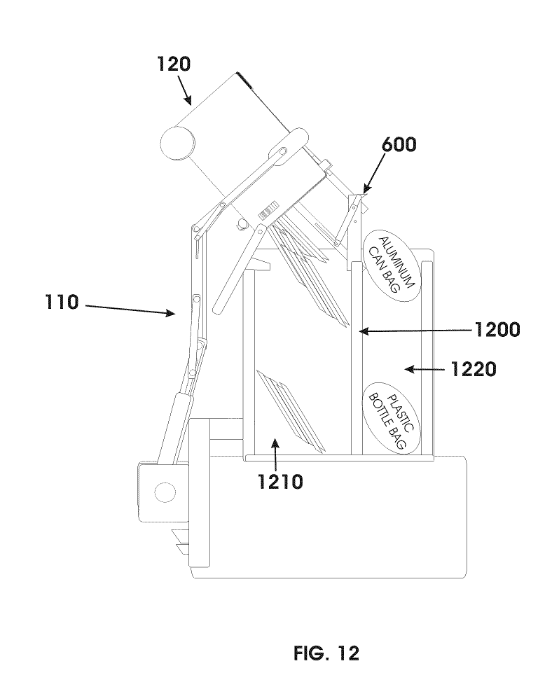

FIG. 12 illustrates the compartment 600 being utilized to sort recyclables. The load bearing medium 700 is received by the groove 1130 when the container 120 is to be dumped and the back wall 720 is dropped. The storage unit 140 includes a wall 1200 to divide it into two sections 1200, 1210. This arrangement enables the contents (e.g., newspaper) from the side 1120 to enter section 1210 and the contents (cans, bottles) to enter section 1220.

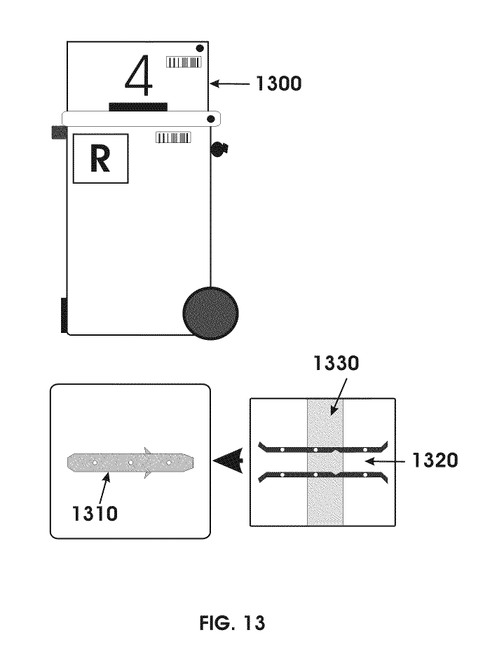

FIG. 13 illustrates an embodiment of a container 120 (refuse and/or recycling) that is equipped to have another container 1300 secured to the top of it. The container 1300 may be used for storing contents that typically require special pick-up such as electronics, oil, paint, and batteries. The top of the lid on the container 120 may include a rail 1310 and the bottom of the container 1300 may include a groove 1320. The rail 1310 and the groove 1320 may be used to secure the two containers 120 and 1300. The bottom of the container 1300 may also include a channel 1330 to be used to route and secure the container to top of the vehicle 100.

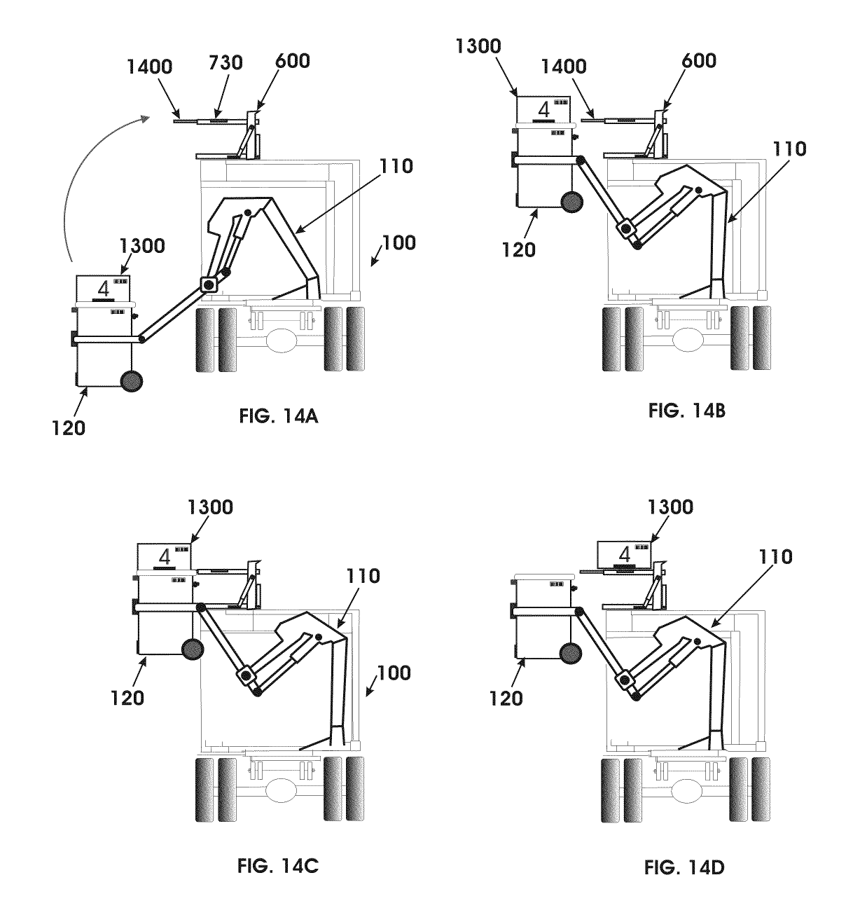

FIGS. 14A-D illustrate the container 1300 being removed from the container 120 using the compartment 600. The upper wall 730 may include a removal arm 1400 extending therefrom. The removal arm 1400 may be inserted into the groove 1320 and disengage the rail 1310 therefrom and accept the container 1300 thereon. The container 1300 mat continue to slide onto the top of the upper wall 730 where the side walls 710 may stop it. The upper wall may also have a channel formed therein in alignment with the channel 1330 in the bottom of the container 1300. After the container 1300 is removed the remainder of the contents in the container may be dumped as previously discussed.

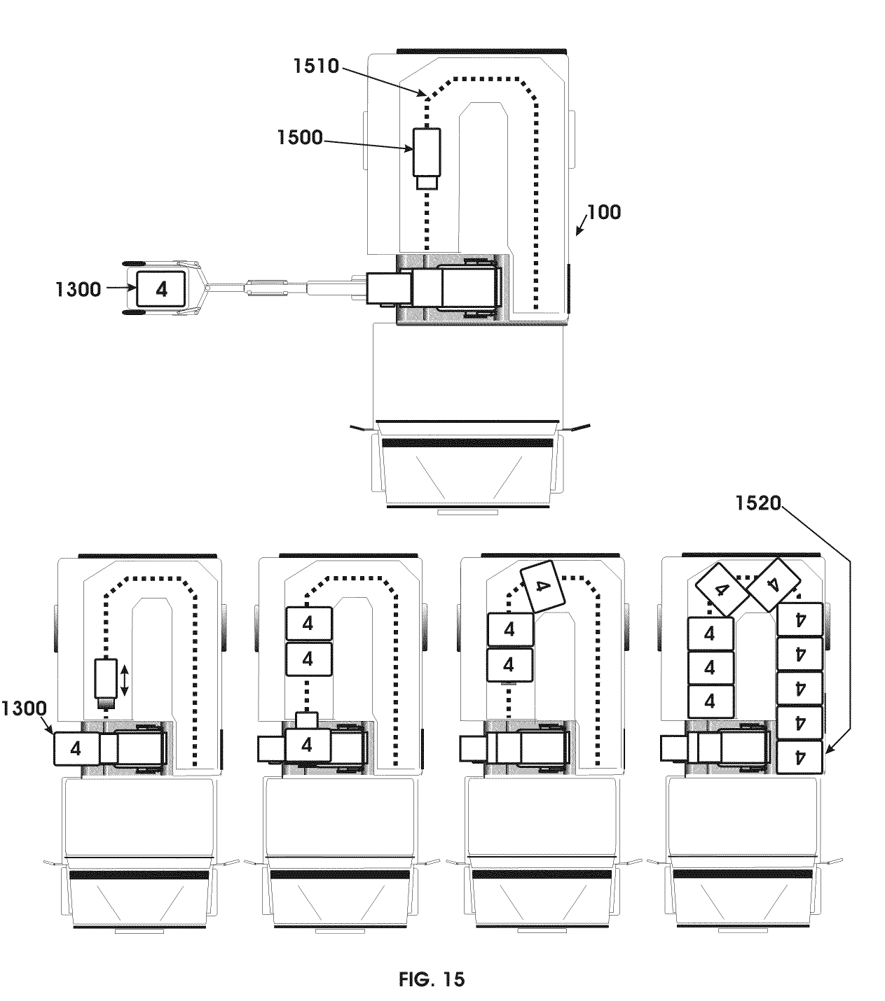

FIG. 15 illustrates the top of the vehicle 100 receiving the container 1300. The top of the vehicle 100 may be configured to secure the containers 1300 thereto. A catch 1500 may slide back and forth along a track or on a pulley 1510 to retrieve the containers 1300 from the upper wall 730 and pull them onto the vehicle roof. The containers 1300 may be pulled to the next open spot. The containers 1300 may be removed from the vehicle 100 at an off-load location 1520. The catch 1500 may enter the channel on the upper wall in order to secure to the channel 1330 of the container 1300 and then may pull the container off

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A collection vehicle comprising
an arm arrangement to automatically pick up a waste container from the ground and dump the contents of the waste container into the vehicle;
sensors to determine when the arm is within a defined window of operation;
a hydraulic control system to control the hydraulics of the arm arrangement, wherein the hydraulic control system will maintain a constant speed of the arm arrangement within the defined window;
stress sensors located on the arm arrangement to measure the strain on the arm arrangement within the defined window;
means to determine customer associated with the waste container;
a central processing unit to covert the strain measurements to weight measurements and to associate the weight measurements to the customer;
interface to transfer the weight per customer data to a billing system.

2. The collection vehicle of claim 1, further comprising a compartment to receive the contents of the waste container prior to the contents entering a collection unit in the collection vehicle.

3. The collection vehicle of claim 2, wherein the compartment weights the contents prior to dumping the contents in the collection unit.

4. The collection vehicle of claim 3, wherein the compartment includes acoustic weight sensors.

5. The collection vehicle of claim 1, wherein the compartment includes hazardous material sensors.

6. The collection vehicle of claim 1, wherein the collection unit is divided into a refuse section and a hazardous section and the compartment dumps the contents into an appropriate section based on measurements by the hazardous material sensors.

7. A collection vehicle comprising
an arm arrangement to automatically pick up a waste container from the ground and dump the contents of the waste container into the vehicle;
sensors to determine when the arm is within a defined window of operation;
a hydraulic control system to control the hydraulics of the arm arrangement;
a compartment to receive the contents of the waste container prior to the contents entering a collection unit in the collection vehicle, wherein the compartment weights the contents prior to dumping the contents;
means to determine customer associated with the waste container;
a central processing unit to associate the weight measurements to the customer; and
interface to transfer the weight per customer data to a billing system.

8. The collection vehicle of claim 7, wherein the compartment includes hazardous material sensors.

9. The collection vehicle of claim 8, wherein the collection unit is divided into a refuse section and a hazardous section and the compartment dumps the contents into an appropriate section based on measurements by the hazardous material sensors.
